(19) United States
(12) Patent Application Publication
(10) Pub. No.: US 2009/0211998 A1
(43) Pub. Date: Aug. 27, 2009

(54) INTELLIGENT CONTROLLED PASSIVE BRAKING OF A RAIL MOUNTED CABLE SUPPORTED OBJECT

(75) Inventors: DALONG GAO, Troy, MI (US); ROBIN STEVENSON, Bloomfield, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/388,729

(22) Filed: Feb. 19, 2009

Related U.S. Application Data
(60) Provisional application No. 61/031,152, filed on Feb. 25, 2008.

(51) Int. Cl. B66C 13/06

(52) U.S. Cl. 212/275

(57) ABSTRACT

A lift system for lifting and moving heavy parts in an assembly environment. The system includes an overhead cart that travels along a rail. A cable connected to the cart is coupled to the part to lift and move the part. The cart includes a braking device and a controller that controls braking of the cart on the rail. When the cart is moving along the rail, and the worker wishes to stop the part at the assembly location, the worker can initiate the braking operation of the cart by pressing a button. The braking device and the controller control the braking of the cart by applying and releasing the brake in a manner determined by the mass of the cart and the mass of the part so that as the cart is being stopped, the part is prevented from swinging.

### CROSS-REFERENCE TO RELATED APPLICATIONS

This application claims priority to U.S. Provisional Patent Application Ser. No. 61/031,152, filed Feb. 25, 2008, entitled “Intelligent Controlled Passive Braking of A Rail Mounted Cable Supported Object.”

### BACKGROUND OF THE INVENTION

1. Field of the Invention

This invention relates generally to a system for supporting a part using a cable suspended from an overhead cart riding on a rail and, more particularly, to a system for supporting a part using a cable suspended from an overhead cart riding on a rail, where the system includes a braking device and related control for braking the cart and preventing the part from swinging on the cable.

2. Discussion of the Related Art

Various parts in a manufacturing and/or assembly process are too heavy for a worker to lift and move from a storage location without assistance. For example, in an automotive assembly environment, it is desirable at one stage of the assembly process to lift an engine and move it to the vehicle body where it is installed. Because the engine is too heavy for the worker to lift or lift safely, some type of lift assist device is needed to help the worker move the part to the appropriate location.

In one known lifting system, a cart is provided that travels on an overhead rail where a cable including an attachment device, for example, a hook, is suspended from the cart. The worker will connect the attachment device to the part at the storage location and press a button that causes a lift motor on the cart to wind the cable on a drum so that the part is lifted. When the part gets to the desired height, the worker will release the button causing the lift motor to stop rotating. As the part is suspended on the cable, the worker can then push the part in the direction of the vehicle. In one known system, sensors on the cart will detect the motion and direction of the cable, and a controller on the cart will activate a drive motor that causes wheels on the cart to rotate and move the cart along the rail towards the vehicle. When the part is at the proper location, the worker will apply pressure against the movement of the part, which is detected by the sensors on the cart, and which causes the drive motor to stop the cart. The worker then lowers the part to the assembly location, where it is installed on the vehicle. The worker will then disconnect the cable from the part, and push the cable in the opposite direction so that the cart returns to the storage location to pick up the next part.

In another known part lifting system, the motor that moves the cart along the rail is not provided, where the worker moves the part connected to the cart by providing manual force applied to the part that cause the cart to move on the rail. Once the part is moving, the worker needs to stop the part at the proper location by providing significant pressure against the moving part in order to stop the part.

### SUMMARY OF THE INVENTION

In accordance with the teachings of the present invention, a power lift system is disclosed for lifting and moving heavy objects in a manufacturing and/or assembly environment. The system includes an overhead cart that travels along a rail. A cable connected to the cart is coupled to the part to lift and move the part. The cart includes a braking device and a controller that controls braking of the cart on the rail. When the cart is moving along the rail, and the worker wishes to stop the part at the assembly location, the worker can initiate the braking operation of the cart by pressing a button. The braking device and the controller control the braking of the cart by applying and releasing the brake in a manner determined by the mass of the cart and the mass of the part so that as the cart is being stopped, the part is prevented from swinging.

Additional features of the present invention will become apparent from the following description and appended claims, taken in conjunction with the accompanying drawings.

### BRIEF DESCRIPTION OF THE DRAWINGS

FIG. 1 is an illustration of a lifting system including an overhead cart traveling along a rail;

FIG. 2 is an illustration of the cart in the system shown in FIG. 1 including a braking device and controller, according to an embodiment of the present invention;

FIG. 3 shows a system modeled as a two mass-spring-damper model for equation (1); and

FIGS. 4-7 are graphs that show various braking actions of a cart traveling on a rail, according to the invention.

### DETAILED DESCRIPTION OF THE EMBODIMENTS

The following discussion of the embodiments of the invention directed to a power lifting system including an overhead cart employing a braking device for lifting heavy parts during an assembly process is merely exemplarary in nature, and is in no way intended to limit the invention or its applications or uses. For example, the lifting system of the invention has particular application in an automotive assembly environment. However, as will be appreciated by those skilled in the art, the lifting system of the invention has application for other assembly and/or manufacturing environments.

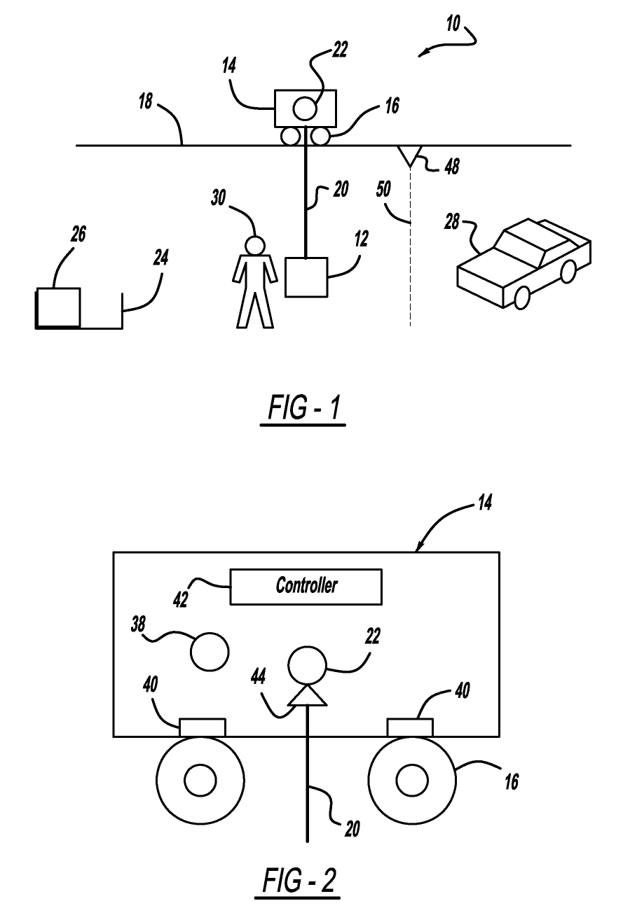

FIG. 1 is an illustration of a power lifting system 10 that has application for lifting a heavy part 12, such as an engine or engine block, in a manufacturing and/or assembly environment, according to an embodiment of the present invention. The system 10 includes a cart 14 having wheels 16 that are coupled to and roll along one or more rails 18. A cable 20 is coupled to the cart 14. A lift motor 22 rotates a drum (not shown) to which the cable 20 is attached so that the cable 20 is wound or unwound thereon to lift or lower the part 12. In this non-limiting example, the part 12 is stored in a bin 24 along with other parts 26, generally proximate to an assembly line. The part 12 is moved from the bin 24 to a vehicle 28 where it is being installed. In a powered system, a worker 30 controls the position of the cart 14 by operating a drive motor 38 by means of a suitable control, such as a pushbutton. The worker 30 also uses a switch (not shown) to cause the lift motor 22 to raise and lower the part 12 at the appropriate time. As the drive motor 38 moves the cart 14 along the rail 18 towards the vehicle 28, the worker 30 will at some point press the pushbutton to deactivate the drive motor 38 and stop the part 12 at the desired location.

In a manual system, only a lift motor is provided where the lateral motion of the part 12 is provided by the worker 30 applying pressure to the part 12, which is communicated through the cable 20 to the cart 14, thereby moving the cart 14. When the part 12 is at the desired location, the worker 30 will apply pressure to the part 12 in the reverse direction to stop both the part 12 and the cart 14. Lift systems that operate in this manner are well known to those skilled in the art and a more detailed discussion of their operation need not be provided herein for a proper understanding of the invention.

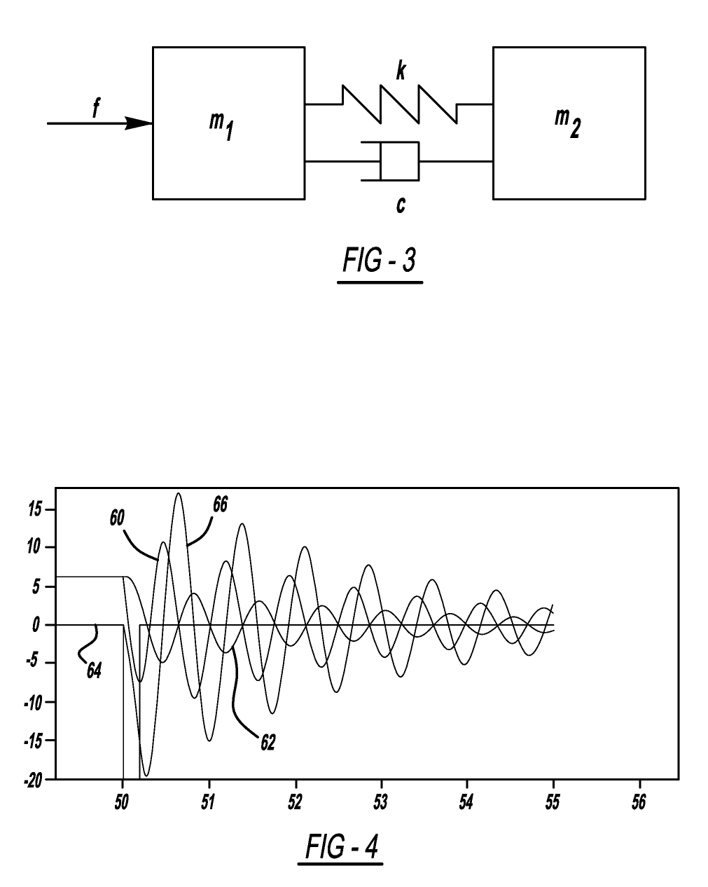

FIG. 2 is an illustration of the cart 14 separated from the system 10, where the cart 14 includes a braking device 40, according to an embodiment of the invention. In this non limiting embodiment, the braking device 40 is on the wheels 16 of the cart 14. The braking device 40 can be any braking device suitable for the purposes disclosed herein. As will be discussed in detail below, the braking device 40 operates to prevent the part 12 from swinging on the cable 20. A controller 42 controls the application and release of the braking device 40 consistent with the discussion below to prevent the part 12 from swinging. More particularly, the present invention proposes a control scheme used by the controller 42 for controlling the braking device 40 on the cart 14 in relation to the mass of the cart 14 and the mass of the part 12, so that the cart 14 decelerates and accelerates on the rail 18 when a command to stop the part 12 is given that prevents the part 12 from vibrating or significantly swinging on the cable 20. By knowing the mass of the cart 14 and the mass of the part 12, the natural frequency of the part 12 on the cable 20 can be calculated, which can be used to control the braking and movement of the cart 14 to prevent the part 12 from swinging.

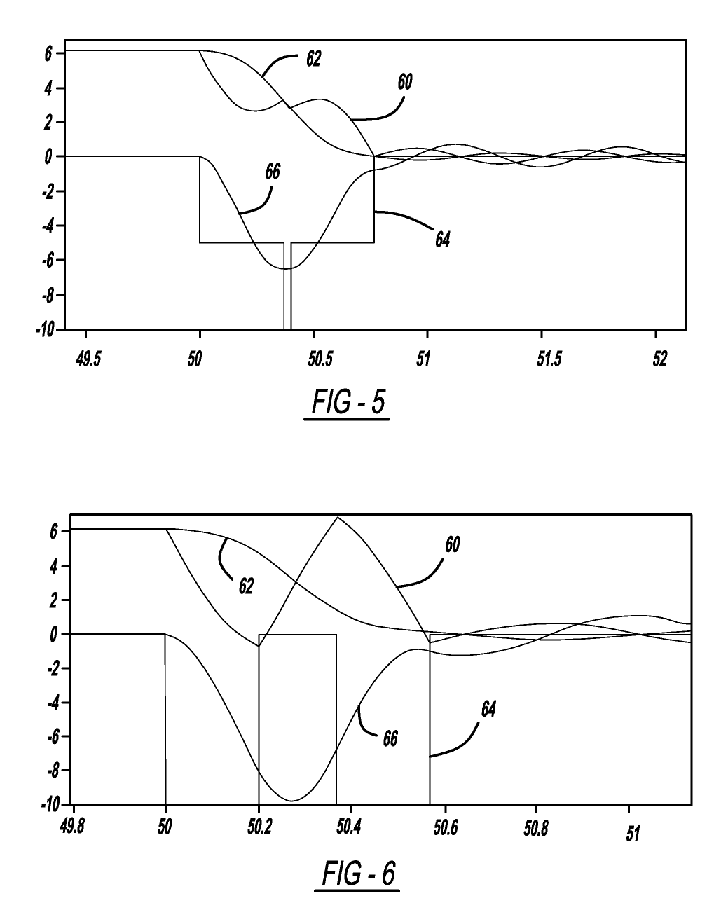

The relationship that is used by the controller 42 to determine the time t when to apply and release the braking device 40 requires an understanding of the system dynamics that are defined by the mass of the cart 14, the mass of the part 12, the length of the cable 20 between the cart 14 and the part 12 and friction. The system can be linearized using a two mass-spring-damper model, such as shown in FIG. 3, and the period T of the system can be found from its natural frequency using the parameters of the linearized system from equation (1) below.

$$T = \frac{2 π}{\sqrt{\frac{k}{{m}_{1}} + \frac{k}{{m}_{2}}} \sqrt{1 - \frac{{( \frac{c}{{m}_{1}} + \frac{c}{{m}_{2}} )}^{2}}{4 ( \frac{k}{{m}_{1}} + \frac{k}{{m}_{2}} )}}} \qquad ( 1 )$$

When the cart 14 is moving, a single application of a braking impulse of the cart 14 on the rail 18 will dissipate at least some of the kinetic energy of the cart 14, which tends to slow down the cart 14. The part 12 will tend to swing forward relative to the part position, which will apply a lateral (pulling) force to the cart 14 through the cable 20. During this braking period, the force transferred by the cable 20 would partially exchange the kinetic energy of the part 12 to the cart 14 and thereby seek to accelerate the cart 14. As the part 12 swings higher, the force applied through the cable 20 will have a larger horizontal component. As a result, the cart 14 might actually be speeded up during a period when braking is applied. At this time, neither the position nor the speed of the cart 14 and the part 12 will be identical, and because energy can be transferred between the cart 14 and the part 12 via the cable force, both the cart 14 and the part 12 will exhibit oscillations. This would manifest itself as vibrations of the cart 14 and the part 12. Hence, the result of a single braking pulse will dissipate the system energy, but induce vibrations that will be especially troublesome in the part 12.

The occurrence of these vibrations may be reduced or eliminated if instead of a single braking pulse, the braking restraint is applied through the application of multiple pulses at specified time intervals. The simplest case is two pulses of equal magnitude applied at a time interval corresponding to one-half of the natural period of the system. That is at time intervals half of those specified by equation (1).

The procedure for two pulses will ensure that the vibrations induced by the second braking pulse will be generally out of phase with the vibrations induced by the first pulse and the sum of the effects of the two pulses will be that the two opposing vibratory actions will cancel and reduce or eliminate the vibration of the part 12.

The procedure as described will reduce the velocity of the part 12, but will not necessarily remove all of the kinetic energy of the system. To stop the part 12, it is necessary that the total energy dissipated in the braking pulses equal the initial energy of the system.

Generally, pulse braking will not be achievable and braking actions of finite magnitude and duration will be employed. A number of pulse magnitude and pulse duration combinations may be employed to dissipate the systems total energy. For example, a relatively low restraining force may be applied for a long time period or a high restraining force may be applied for a short time period. Additionally, a multiplicity of pulses can be employed.

The appropriate combinations of magnitude, duration and time interval may be more conveniently evaluated using a representation of the system capable of evaluation in a digital computer.

As before, the system response to a signal braking action and associated restraining force is to vibrate. The characteristics of the vibration at the end of the input can be obtained using the system transfer function in conjunction with the force input information.

When subjected to another braking action at a later time, the system response to this later input will be superimposed on the existing motions. Hence the characteristics of the vibrations at the end of the second input can be similarly obtained. By establishing the requirement that the amplitude of the vibrations caused by both inputs sum to zero at the conclusion of both inputs, the desired time separation between the two selected inputs can be computed.

If the two inputs to be used are two identical braking forces with constant force values, the system should have no residual vibrations at the part 12 after these inputs, provided the time separation between them is half of the natural period of this system. This result is the same as predicted using equation (1).

The procedure described for the two-input example can be generalized. Thus, alternate braking profiles with different numbers of individual inputs, different braking force profiles and corresponding time separations between adjacent inputs can be designed to obtain significantly reduced or no vibration at the part 12 at the end of the last input.

The procedure described assumes that the system energy is continually reduced throughout the duration of the braking action. Generally, this will be the case. However, an alternate situation can arise in which the braking action is being applied even when the cart 14 is stopped. Under this situation, the braking device 40 is incapable of extracting additional energy from the system. When this occurs, the energy assumed extracted during the braking action will be less than its theoretical value and the energy requirement described above will be violated leading to an inability to stop the cart 14. This situation may also lead to an inability to stop the vibrations if unequal energies are extracted by sequential braking actions.

The above situation can be generalized to any situation in which the forward force exerted by the cart 14 is less than the braking force. Again, a passive brake would be incapable of fully extracting all of the systems energy with the result described above.

The situation described above will not occur when active braking is employed. In an alternate embodiment, which may be employed in a motor driven system, motor reversal may be employed to achieve the braking action. In this case, the motor may continue to apply force and temporarily induce cart motion in the opposite direction, which will be overcome by the motion of the part 12 when the braking action ceases.

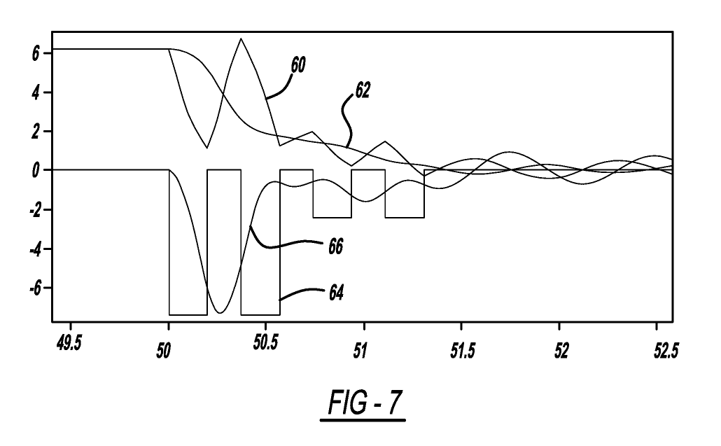

These considerations can be more fully understood by reviewing the graphs in FIGS. 4-7, where time is on the horizontal axis and force is on the vertical axis. In these graphs, reference number 60 is for the velocity of the cart 14, reference number 62 is for the velocity of the part 12, reference number 64 is for the braking force on the cart 14 and reference number 66 is for the horizontal cable tension.

FIG. 4 shows the system response to a single braking action and demonstrates the vibrations which result.

FIG. 5 shows the system response to a near-optimal double braking action of equal magnitude in which the time period between the braking actions is less than duration of the action. This yields an overall braking response that resembles a short duration spike superimposed on a longer duration lower magnitude force exertion. Note that at the conclusion of the action, the part 12 shows only a very low amplitude vibration. Note also that under this braking scheme, the cart velocity is reduced to zero only at the conclusion of the braking action.

FIG. 6 shows a similar near-optimal double braking action in which the indicated cart velocity is reduced below zero. This is an accurate representation of behavior when motor braking or active braking is employed, but under passive braking would lead to a mis-match between the energy extracted by the braking device 40 and the initial system energy, and would be a less effective braking scheme.

FIG. 7 shows a four braking action scheme demonstrating that more than two braking actions may be used and also that the magnitude of the individual braking actions need not be identical to achieve a near-optimal suppression of the vibrations.

In practice, as the worker 30 is pushing the part 12 towards the assembly location, there will be some location where the worker 30 knows to activate the braking device 40 so that the speed and momentum of the part 12 and the distance needed to prevent the part 12 from swinging allows the cart 14 to completely stop at the proper location for the placement of the part 12. Thus, the control technique is an open-loop system based on the knowledge of the mass of the cart 14 and the mass of the part 12.

In the design discussed above, a motor does not need to be provided to move the cart 14 along the rail 18. As noted previously, in an alternate embodiment, where a motor is provided to propel the cart 14 along the rail 18, the braking application could be provided by reversing the rotation of the motor. This assures that the full program energy dissipation of the braking action will be achieved even if the cart motion is reduced to zero prior to the cessation of the braking action.

In another alternate embodiment, some type of sensing system or vision system can be employed so that when the cart 14 reaches the proper braking location, a signal is provided that automatically initiates the braking sequence that stops the part 12 at the proper location without the part swinging. In order to illustrate this embodiment, the system 10 includes a light source 48 that emits a beam 50 to detect the part 12 when it is close to the vehicle 28, and initiate the braking sequence.

As discussed above, the algorithm that calculates the starting and stopping of the cart 14 to prevent the part 12 from swinging is based on the mass of the cart 14 and mass of the part 12. Therefore, for each different part, such as different size engines, the application and release of the braking device 40 and the cart 14 would change as well as the distance needed to stop the part 12 at the proper location. Because the weight of the cart 14 and the part 12 would be known, the worker can select a suitable algorithm for the particular part being assembled at a particular time. The present invention also envisions providing a load cell 44 somewhere along the cable 20, such as where the cable 20 attaches to the cart 14, that provides the weight of the part 12, where the controller 42 would automatically select the proper algorithm depending on the weight.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for moving a part, said system comprising:
a rail;
a cart including wheels that travel along the rail, said cart further including a braking device that causes the cart to brake on the rail, said cart further including a controller that controls the braking device; and
a cable coupled to the cart and including a connecting device for connecting the part to the cable, wherein the controller controls the braking device in response to a command to stop the cart where the controller applies and releases the braking device in a manner that substantially prevents the part from swinging on the cable.

2. The system according to claim 1 wherein the cart includes a motor for moving the cart along the rail.

3. The system according to claim 2 wherein the braking device includes operating the motor in a reverse direction.

4. The system according to claim 1 wherein the cart moves along the rail in response to a worker applying pressure to the part.

5. The system according to claim 1 wherein the command to stop the cart is provided by a worker pressing a button.

6. The system according to claim 1 further comprising a sensor for detecting when the part is at a desired location, said sensor providing the command to stop the cart.

7. The system according to claim 1 further comprising a load cell that measures the weight of the part.

8. The system according to claim 1 wherein the controller uses the mass of the cart and the mass of the part to provide an algorithm for the braking control that applies and releases the braking device to prevent the part from swinging on the cable.

9. The system according to claim 1 wherein the part is a part on a vehicle.

10. The system according to claim 9 where the part comprises an engine block.

11. A system for moving a part, said system comprising:
a rail;
an overhead cart coupled to the rail, said cart including a braking device and a controller for controlling the braking device, said braking device operating to reduce the speed of the cart as it moves along the rail; and
a cable coupled to the part and including a connecting device for connecting the part to the cable.

12. The system according to claim 11 wherein the controller controls the braking device in a manner that applies and releases the braking device so that the part is prevented from swinging on the cable.

13. The system according to claim 12 wherein the controller uses an algorithm based on the masses of the cart and the part to provide the braking control that applies and releases the braking device to prevent the part from swinging on the cable.

14. The system according to claim 11 wherein the cart moves along the rail in response to an operation applying pressure to the part.

15. The system according to claim 11 wherein a command to stop the cart is provided by a position sensing system.

16. The system according to claim 11 wherein a command to stop the cart is provided by a worker pressing a button.

17. A lifting system for lifting and moving a part, said system comprising:
a rail;
a cart including wheels that travel along the rail, said cart further including a braking device that causes the cart to brake on the rail, said cart further including a controller that controls the braking device;
a cable coupled to the cart and including a connecting device for connecting the part to the cable; and
a first motor for winding and unwinding the cable to lift and lower the part, wherein the cart moves along the rail in response to a worker applying pressure to the part, and wherein a command to stop the cart is provided by an operator, and wherein the controller controls the braking device in response to a command to stop the cart where the controller applies and releases the braking device in a manner that substantially prevents the part from swinging on the cable, wherein the controller uses the relative mass between the cart and the part to provide the braking control that applies and releases the braking device to prevent the part from swinging on the cable.

18. The system according to claim 17 wherein the command to stop the cart is provided by the operator pushing a button.

19. The system according to claim 17 wherein the cart includes a second motor for moving the cart along the rail.

20. The system according to claim 17 further comprising a load cell that measures the weight of the part.
